(19) United States
(12) Patent Application Publication
(10) Pub. No.: US 2006/0288494 A1
(43) Pub. Date: Dec. 28, 2006

(54) Process for producing leather

(75) Inventor: Franciscus Cornelis Marie Metsaars, Whitehall, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: Wolverine World Wide, Inc.

(21) Appl. No.: 11/166,760

(22) Filed: Jun. 24, 2005

(51) Int. Cl. C14C 3/04

(52) U.S. Cl. 8/94.26

(57) ABSTRACT

A method for producing leather generally including the steps of: (a) providing wet blue, full grain skins, (b) applying a degreasing and emulsifying agent to the skins, (d) neutralizing the skins to provide the skins with a pH level of in the range of about 5.7-6.2, (e) applying a waterproofing agent to the skins, (f) introducing the skins to a dye bath, (g) fixing the dyestuff and waterproofing agents in the skins without metal salt while reducing the pH level to about −3.2, (g) applying a water repellant and oil repellant agent to the skins in a fluorchemical process, (h) fixing the skins a second time without metal salt while moving the pH level to the range of 3.0-3.5, (i) introducing the skins to a bath containing an antimicrobial treatment and an antistatic treatment, (j) washing and drying the skins, and (k) staking and otherwise finishing the skins.

### BACKGROUND OF THE INVENTION

The present invention relates to methods for the production of leather, and more particularly to a process for producing leather from wet blue pig skins.

A wide variety of methods are used commercially for producing leather from skins or hides. In general, leather production involves three broad phases. First, the skins or hides are prepared for tanning. This generally involves curing the skins so that they do not begin to decompose before tanning. At the tannery, the skins are typically soaked in water to remove all water-soluble materials, such as salt, blood, and dirt, and to replace moisture lost in the curing process. Typically, the next step is to remove hair from the skins. Often, this is done by soaking the skins in a lime solution and then mechanically removing the hair, along with extraneous flesh and tissue, by machine. The next general step is “deliming,” which removes the lime introduced during the dehairing step. The deliming process involves soaking the skins in a mild acid solution. Bating may also occur at this time. Bating is a process in which the skins are treated with enzymes that make the skins soft and flexible and provide them with a smoother grain.

The bated skins are then tanned using any of a variety of conventional tanning methods. For example, the skins may be tanned in a mineral tanning process. In mineral tanning, the skins are soaked in a mineral tanning agent, typically the salt compound of chromium. To prepare the bated skins for chrome tanning, the skins are pickled in a conventional salt and acid brine. Once pickled, the skins are tumbled in a chromium-sulfate solution containing liquors that enhance the skins' ability to absorb the tanning agent. Alternatively, the skins may be tanned in a vegetable tanning process. Vegetable tanning generally involves soaking the skins in a tannin solution containing liquors that improve and speed the absorption of tannin. Tannin is typically extracted from wood or bark, such as the chestnut wood or oak bark. The skins are soaked in successively stronger solutions until they have absorbed the appropriate amount of tannin for the particular application.

The tanned skins, which in the case of chrome tanned skins are sometimes referred to as “wet blue leather,” are then subjected to a variety of treatments that provide the skins with the desired characteristics. For example, the skins can be lubricated using a blend of oils and greases, and dyed to the desired color through drum dyeing, spraying, brush dyeing or staining processes. In some applications, the skins are retanned to introduce additives that provide the skins with desirable characteristics. For example, waterproofing agents are typically introduced during a retanning process. Waterproofing is a particularly important characteristic in many applications, including footwear applications. The waterproofness of leather is typically measured in Maeser flexes, which is essentially the number of flexes that leather can undergo before it loses the waterproof characteristic. The waterproofness standard set by the U.S. military is 15,000 Maeser flexes. Further, heat resistant and flame resistant agents are often introduced prior to and/or during the retanning process. Finally, the skins are staked and finished. Staking is a mechanical softening process in which the skins are repeatedly beat by fingers. Finishing typically involves the application of a finishing compound, such as oil blend, to the surface of the leather. The above described processes are typical steps involved in the production, but are not exhaustive. Alternative and additional processes are commonplace in the leather production industry.

Although there are a variety of well-known techniques for obtaining leather with one or more desired characteristics, such as softness, suppleness, waterproofness, flame resistance, and heat resistance, it is difficult to produce leather that has the appropriate combination of these characteristics. In fact, these characteristics are achieved only by carefully controlling a complex series of variables in the production process. For example, the precise additive formulation, the quantity of additives, the mixture ratio of additives to water in the various steps, the temperature of the solutions in which the skins are treated, the running time in a given liquor bath and the pH level of the solutions in which the skins are treated are all crucial to the production process. In many cases, the procedures for providing the leather with one desirable characteristic adversely affect other desirable characteristics. Accordingly, leather processing often involves a careful and delicate balance of processing techniques and additive choices.

In conventional processes, the skins are capped to remove or inactivate emulsifying agents. Capping typically involves the introduction of a metal salt that interacts with the emulsifying agent rendering it inactive. Although capping can improve the overall performance of the finished leather, it can have a number of disadvantages. For example, capping can cause the leather to shrink, thereby reducing the yield. Also, capping can have a negative impact on the ability of the leather to readily and uniformly accept coloring and dyes. In fact, capping can make it nearly impossible to obtain certain colors. As a result, capping can make it difficult or impossible to obtain uniform and even coloring of leather. This is particularly true with bright colors, which have a tendency to more clearly show any discontinuity in color. Accordingly, leather produced in a process involving a conventional capping step is typically not colored or dyed using bright colors. Rather, these leathers are typically colored using dark colors that inherently show less discrepancy in coloring.

As perhaps the result of these complexities, there remains an unmet need for leather that is soft and supple while at the same time being durable, highly oil resistant, water resistant and uniformly accepting of dyestuffs.

### SUMMARY OF THE INVENTION

The aforementioned problems are overcome by the present invention wherein a leather production process is provided which produces leather that is soft and supple, yet durable, highly oil resistant, water resistant, while at the same time being suitable for use with bright colors. The production process generally includes the steps of: (a) providing wet blue, full grain skins, (b) applying a degreasing and emulsifying agent to the skins, (d) neutralizing the skins to provide the skins with a pH level of in the range of about 5.7-6.2, (e) applying a waterproofing agent to the skins, (f) introducing the skins to a dye bath, (g) fixing the dyestuff and waterproofing agents in the skins without chrome or other metal salts while reducing the pH level to about −3.2, (g) applying a water repellant and oil repellant agent to the skins in a fluorchemical process, (h) fixing the skins a second time without chrome or other metal salts while moving the pH level to the range of 3.0-3.5, (i) introducing the skins to a bath containing an antimicrobial treatment and an antistatic treatment, (j) washing and drying the skins, and (k) staking and otherwise finishing the skins. If desired, the skins can also be subjected to additional treatments, such as flame resistant/flame proof treatments.

In one embodiment, the skins are washed and drained after the neutralizing step, but not between the waterproofing and coloring steps. The first fixing step may occur immediately following the coloring step to fix both the waterproofing agents and the dyestuffs.

In another embodiment, the skins are washed and drained between the first fixing step and the fluorchemical step, but not between the fluorchemical process and the antimicrobial and antistatic treatments.

The present invention produces soft and supple leather that is durable, highly water resistant and oil resistant and that readily and uniformly receiving of dyestuffs. The process therefore provides leather capable of consistently and uniformly receiving color. Because the leather is highly oil resistant and water resistant, the leather is highly stain resistant. As a result of these characteristics, the process is particularly well-suited for use in producing high performance leather in bright colors.

These and other objects, advantages, and features of the invention will be readily understood and appreciated by reference to the detailed description of the preferred embodiment and the drawings.

### BRIEF DESCRIPTION OF THE DRAWINGS

FIG. 1 is a flow chart showing the general steps of the present invention;

FIG. 2 is a flow chart showing the general steps of the degreasing and neutralizing phases;

FIG. 3 is a flow chart showing the general steps of the waterproofing phase;

FIG. 4 is a flow chart showing the general steps of the coloring phase;

FIG. 5 is a flow chart showing the general steps of the fixing phase;

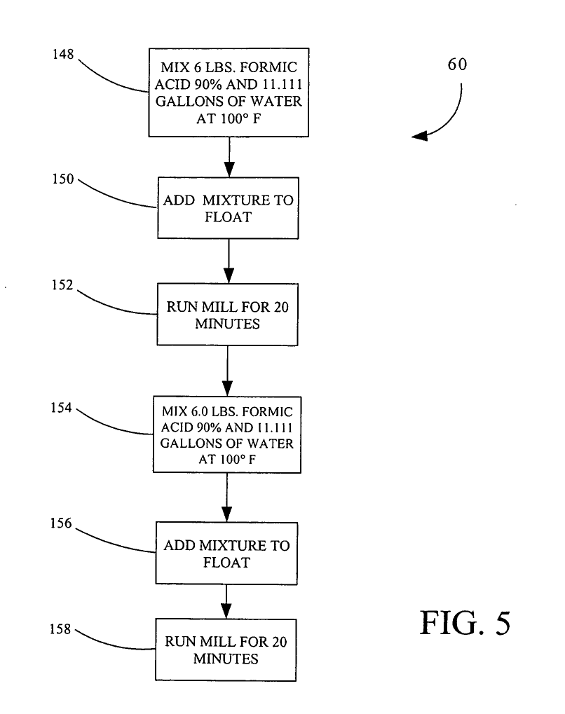

FIG. 6 is a flow chart showing the general steps of the fluorchemical phase; and

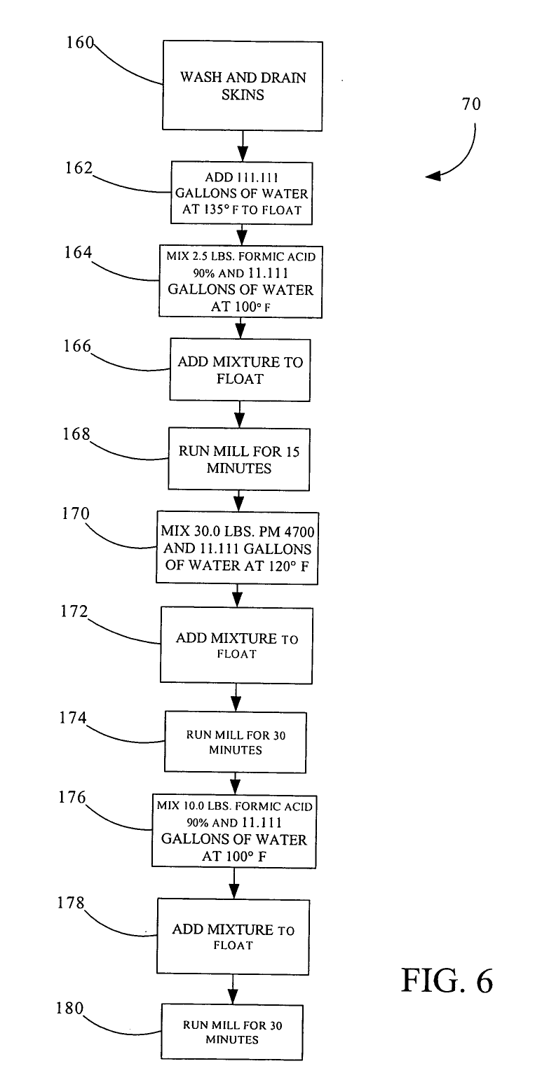

FIG. 7 is a flow chart showing the general steps of the antimicrobial and anti static treatment phases.

### DETAILED DESCRIPTION OF THE PREFERRED EMBODIMENT

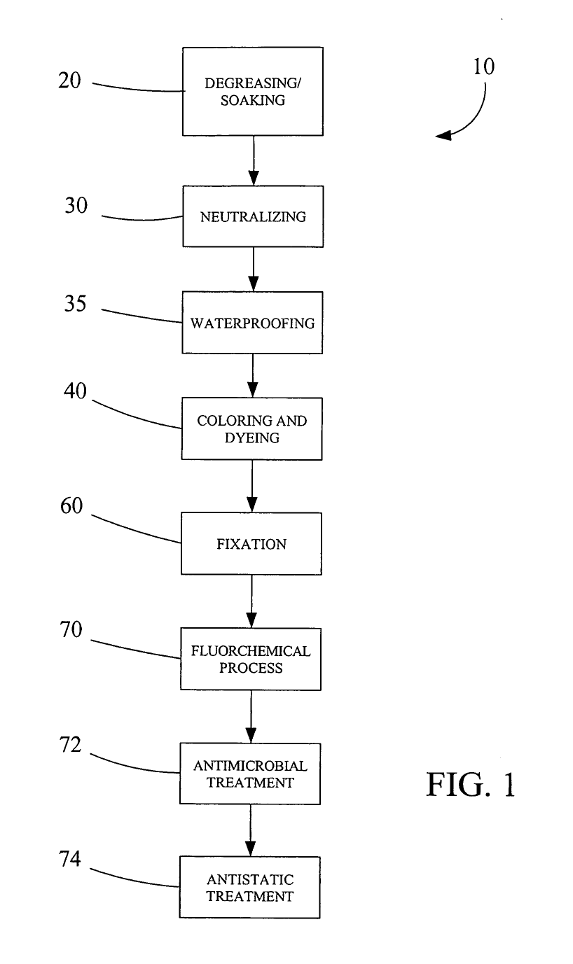

An embodiment of the present invention is described in connection with the flowchart of FIG. 1. As shown in FIG. 1, the present method 10 generally includes the steps of (a) degreasing and soaking the skins 20, (b) neutralizing the skins 30, (c) waterproofing the skins 35, (d) coloring the skins 40, (d) fixing the skins 60, (f) fluorchemical treatment of the skins 70, (g) fixing the skins 72, (h) antimicrobial and antistatic treatment of the skins 74 and (g) staking and finishing the skins 80. Together, these steps provide leather having a unique and highly advantageous combination of features and characteristics, including the ability to be uniformly and consistently colored while at the same time being highly oil resistant and stain resistant. The method is particularly well-suited for use in treating wet blue pig skins, but can be used in whole or in part to treat other skins as well. In some applications, the process may require routine modification to provide optimal results depending, for example, on the type and specific characteristics of the skins to be treated and on the specifically desired characteristics of the finished leather. The manner and degree of any such modifications will be readily apparent to those skilled in the art.

The following description sets forth an embodiment of the present invention that is optimized to provide finished leather with a particular set of desired characteristics. Those skilled in the field will readily appreciate that the specified times and quantities are approximate and that some variation in a specified time or in a specified quantity will typically yield acceptable results in the finished leather, and adjustments can be used to intentionally adjust the characteristics of the finished leather. The amount of acceptable variation in a particular time or quantity will vary depending primarily on the amount of acceptable variance in the finished leather. For example, variations in the range of approximately ±20% in the quantity of a particular additive are likely to be acceptable for each of the additives, except for the acidic and caustic materials used to adjust the pH level of the float (i.e. formic acid, sodium formate, sodium bicarbonate and aqua ammonia). However, even with the acidic and caustic materials, variation in the quantity of a particular additive may be compensated for by adjustment in the strength (e.g. percent of composition) of the additive or in time that the mill is run with the additive in the float provided that the specified pH levels are obtained. It should further be noted that, in the following paragraphs, the percentages of various additives are specified in parentheses following the specified weight or volume quantities. These percentages refer to the weight of the additive with respect to the total weight of the wet blue skins being processed.

In the illustrated embodiment, the process begins by loading the wet blue skins into a conventional mill. In this embodiment, approximately 1000 lbs. of skins are loaded into the mill. Typically, the wet blue skins have a pH of 3.5 or lower. As a first step, the skins may be washed. Initially, approximately 1,000 gallons of water are added to the mill. The water may be at a temperature of approximately 140° Fahrenheit (F.), but the temperature may vary, for example, between 105-150° F. The skins are washed and then the water is drained. After washing, the water is drained from the mill.

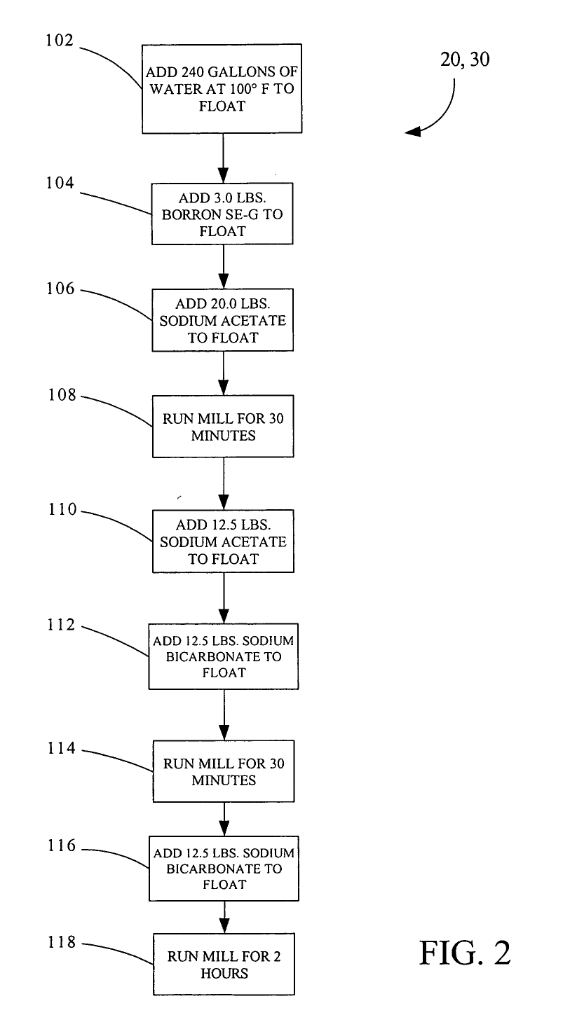

After the initial washing step, the skins undergo the degreasing and neutralizing phase 20, 30 (See FIG. 2). In this embodiment, the two phases are carried out somewhat together. This phase begins by adding 102 approximately 240 gallons of water to the mill to create the float. The water is preferably at a temperature of approximately 100° F., but the temperature may vary, for example, between 80-110° F. Following this, a degreasing agent is added to the mill. In this embodiment, approximately 3 lbs. (or 0.3%) of Borron SE-G (available from TFL USA/Canada Ltd.) is added 104 to the mill through the door. Borron SE-G is a nonionic, degreasing and emulsifying agent, which degreases the skins and prepares them to receive further treatments. Obviously, the Borron SE-G can be replaced by other degreasing/emulsifying agents, as desired. Additionally, approximately 20 lbs. (or 2.0%) of Sodium Acetate are added 106 to the mill. The mill is run 108 for approximately 30 minutes, but the running time may vary, for example, between 20-60 minutes.

Following these steps, the skins are neutralized 30 (See FIG. 2). In the illustrated embodiment, the neutralization process includes two stages. In the first stage, approximately 12.5 lbs. of sodium acetate (or 1.25%) are added 110 to the mill and approximately 12.5 lbs. of sodium bicarbonate (or 1.25%) are added 112 to the mill. The mill is then run 114 for approximately 30 minutes. The mill running time may vary, for example, between 20-60 minutes. This initial step is likely to provide the skins with a pH value of approximately 4.8 or higher.

In the second stage of the neutralization process, approximately 12.5 lbs. of sodium bicarbonate (or 1.25%) are added 116 to the mill. The mill is then run 118 for approximately 2 hours, which will raise the pH level of the skins to a range of approximately 5.7-6.2. The mill running time may vary, for example, between 90-180 minutes.

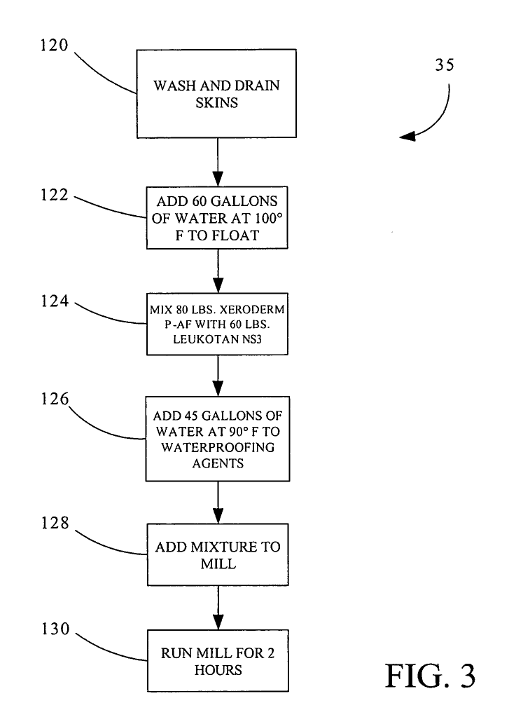

The neutralized skins are next subjected to the waterproofing phase 35 (See FIG. 3). To prepare for the waterproofing phase, approximately 1,000 gallons of water at approximately 100° F. are added to the mill, and the skins are washed and drained 120. The temperature of the water may vary, for example, between 70-100° F. After the skins have been washed, approximately 60 gallons of water is added 122 to the mill to create the float. The water may be at a temperature of approximately 100° F., but vary, for example, in a range of 70-105° F. Then, approximately 80 lbs. (or 8%) of Xeroderm P-AF (available from ______ of ______) and approximately 60 lbs. (6%) of Leukotan NS3 (available from ______ of ______) are mixed 124. Xeroderm P-AF and Leukotan are waterproofing agents that have proven to be well-suited for use in this application. These chemicals may be replaced by other waterproofing agents in alternative applications. Afterwards, approximately 45 gallons of water are combined 126 with the waterproofing agents, and the mix is added 128 to the mill. This water may be at a temperature of approximately 90° F., but its temperature may vary. The mill is then run 130 for approximately 90 minutes. The running time of the mill may vary, for example, between 60 to 120 minutes. After the mill has run, the skins should be at a pH level of approximately 6.5.

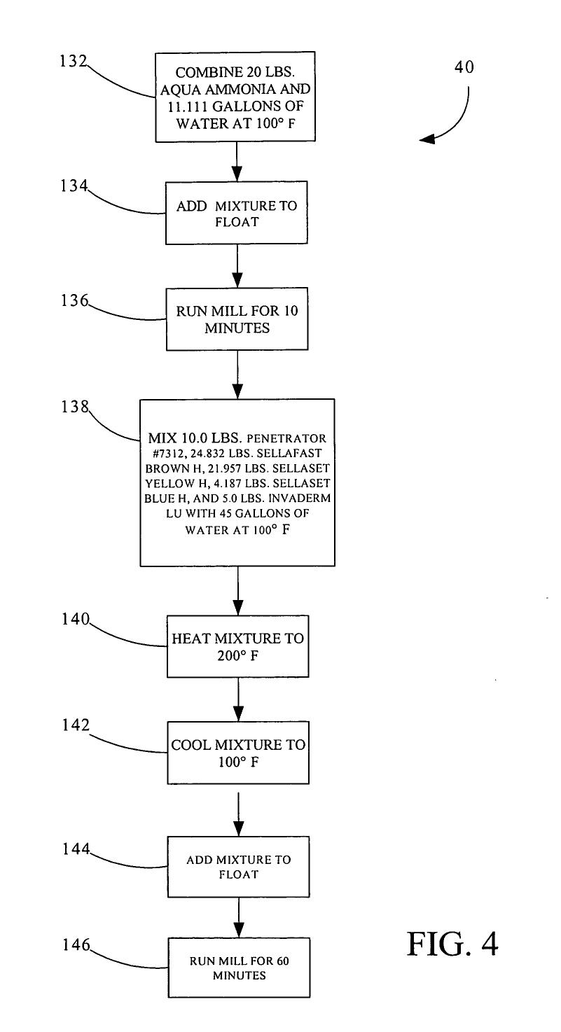

The skins next undergo the coloring and dyeing phase 40 (See FIG. 4). The coloring phase 40 begins by combining 132 approximately 20.0 lbs. (2%) of aqua ammonia (approximately 29% concentration) and approximately 11.111 gallons of water. The water is at a temperature of approximately 100° F., but may vary between 70-105° F. The mixture is added 136 to the mill and the mill is run 136 for approximately 10 minutes. This will bring the skins to a pH level of approximately 7. The dyestuffs are next mixed together with water and the desired penetrators. More specifically, approximately 10.0 lbs. (1%) of Penetrator #7312 available from ______ of ______, approximately 24.832 lbs. (2.48%) of Sellafast Brown H available from ______ of ______, approximately 21.957 lbs. (2.196%) Sellaset Yellow H available from _____ of ______, approximately 4.187 lbs. (0.419%) Sellaset Blue H available from ______ of ______, approximately 5.0 lbs. (0.5%) Invaderm LU available from ______ of ______ and approximately 45 gallons of water at approximately 100° F. are mixed 138 together. The mixture is heated 140 to approximately 200° F. and then cooled 142 to approximately 100° F. The mixture is then added 144 to the float, and the mill is run for approximately 60 minutes. The runtime of the mill vary, for example, from 60 to 180 minutes). Although the described process includes the use of dissolved dyestuff and penetrators, the dyestuff and penetrators may alternatively be added dry, if desired. The Penetrator #7312 and Invaderm LU are commercially available penetrators. If desired, these penetrators may be replaced or supplemented by other conventional penetrating agents. The coloring phase has been described in connection with a collection of three dyestuffs selected to provide the leather with a specific color. These dyestuffs may be replaced by other dyestuff as appropriate to obtain essentially any desired color.

The skins next pass into the fixation phase 60. To aid in fixing 170 the waterproofing agents and dyestuff in the skins, formic acid is added to the mill in two sequential installments. First, approximately 6.0 lbs. (0.6%) of formic acid (90% concentration) is mixed 148 with approximately 11.111 gallons of water at approximately 100° F. The mixture is added 150 to the mill. The mill is run 152 for approximately 20 minutes. The runtime of the mill may vary, for example, between 15 to 45 minutes). Then, a second installment of approximately 6.0 lbs. (0.6%) of formic acid (90% concentration) and 11.111 gallons of water at approximately 100° F. are mixed 154 and added 156 to the mill. The mill is then run for approximately 20 minutes. The runtime of the mill may vary, for example, between 15 to 45 minutes). This should bring the skins to a pH level below approximately 3.5.

A water repellant and oil repellant agent is next added to the skins in a fluorchemical process 70. To prepare for this process, the skins are washed 160 in approximately 2000 gallons of water at approximately 135° F., and the mill is drained 172. The temperature of the water may vary, for example, between 115 to 150° F. The fluorchemical process begins by adding 162 approximately 111.11 gallons of water at approximately 135° F. to the mill to establish the float. Next, approximately 2.5 lbs. (0.25%) of formic acid (90% concentration) is mixed 164 with approximately 11.111 gallons of water at approximately 100° F. The mixture is added 166 to the mill. The mill is run 168 for approximately 15 minutes. The runtime of the mill may vary, for example, between 10 to 30 minutes). These steps should bring the skins to a pH level in the range of 3.2 to 3.6. After, approximately 30.0 lbs. (3%) of PM 4700 is mixed 170 with approximately 11.111 gallons of water at approximately 120° F. The mixture is added 172 to the mill, and the mill is run 174 for approximately 30 minutes. The runtime of the mill may vary, for example, between 20 to 60 minutes). The PM 4700 is a conventional leather protectant that renders the skins oil resistant and water resistant, and is available from 3M under the trade name “Scotch Guard®.” This protectant can be replaced or supplemented by other conventional protectants, if desired. The skins are next treated to fix the protectant in the skins. Approximately 10.0 lbs. (1%) of formic acid (90% concentration) is mixed 176 with approximately 11.111 gallons of water at approximately 100° F. The mixture is added 178 to the mill. The mill is run 180 for approximately 30 minutes. The runtime of the mill may vary, for example, between 20 to 60 minutes). These steps should bring the skins to a pH level in the range of 3.0 to 3.5.

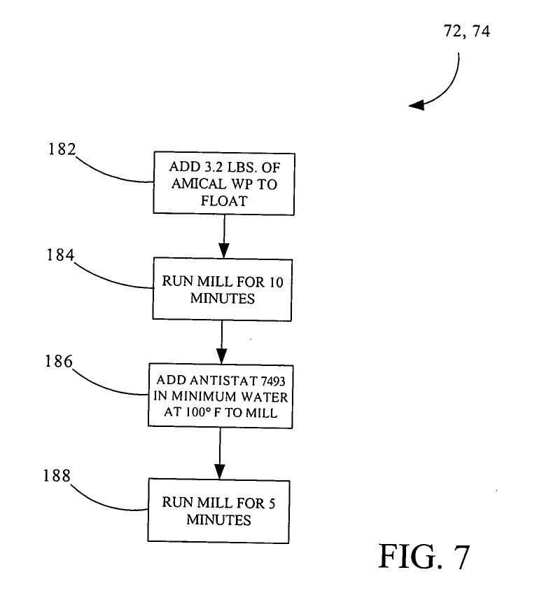

If desired, the skins can be subjected to a variety of additional treatments. These various treatments are option. In one embodiment, the skins are treated with antimicrobial and antistatic treatments (See FIG. 7). More specifically, approximately 3.2 lbs. (0.32%) of Amical WP is dry fed 182 into the mill, and the mill is run 184 for approximately 10 minutes. Amical WP is a conventional antimicrobial treatment that is available from ______ of ______. This additive may be replaced or supplemented with other antimicrobial agents. The runtime of the mill may vary, for example, between 10 to 20 minutes. In addition, approximately 10.0 lbs. (1%) of Antistat 7493 is mixed 186 with a minimal amount of water at approximately 100° F. Antistat 7493 is a conventional antistatic agent that is available from ______ of ______. This agent may be replaced or supplemented with other antistatic agents. The mixture is added 188 to the mill, and the mill is run for approximately 5 minutes. The runtime of the mill may vary, for example, between 5 to 15 minutes. The particular order of application of these two treatments is not particularly important, and they may be applied in reverse order if desired.

If desired, additional treatments may be applied to the skins. For example, a flame resistant or flame proof treatment may be applied. The flame resistant or flame proof treatment may be applied to the skins in a dry or dissolved state, as desired. Further, additional antimicrobial treatments may be applied. Additional antimicrobial treatments may also be applied in a dry or dissolved state.

Next, the skins are subjected to a final washing. Approximately 1000 gallons of water at 100° F. are added to the mill while the mill is running. The washing door of the mill may be left open, permitting the water to slosh from the mill. The mill is run until nearly all of the water has sloshed from the mill. Then, the skins or leathers are dumped from the mill.

The leathers are preferably dried using conventional vacuum dryers or other similar machinery. The dried leathers can be staked and finished 80 as desired. Staking is a mechanical softening process that typically involves beating the leather repeatedly with small fingers. The leathers can also be sanded and milled, as appropriate. The leathers can undergo additional finishing, as desired. For example, oil can be applied to the leather to add to waterproofness and change the look and feel of the leather.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1- A method for producing leather from skins, comprising the steps of:
applying a degreasing/emulsifying agent to the skins;
neutralizing the skins by raising the pH level of the skins to at least approximately 5.7 or above;
applying a waterproofing agent to the skins after said neutralizing step;
coloring the skins after said waterproofing step;
fixing the skins without metal salt after said coloring step by introducing acid to the skins to lower the pH level of the skins below approximately 3.5;
subjecting the skins to a leather protectant in a fluorchemical process while the skins are at a pH level in a range of approximately 3.2-3.6; and
fixing the skins without metal salt after said fluorchemical process by introducing acid to the skins to lower the pH level of the skins below approximately 3.5.

2- The method of claim 1 further comprising the steps of:
applying an antimicrobial treatment to the skins; and
applying an antistatic treatment to the skins.

3- The method of claim 2 further comprising the step of washing the skins after said step and before said fluorchemical process.

4- The method of claim 3 wherein said coloring step includes the steps of:
raising the pH level of the skins to approximately 7.0;
introducing a penetrator to the skins; and
introducing a desired dyestuff to the skins.

5- The method of claim 4 wherein the penetrator and the dyestuff are mixed together before being introduced to the skins.

6- The method of claim 5 further comprising the step of washing the skins after said neutralizing step and before said waterproofing step.

7- The method of claim 6 wherein said step of raising the pH level of the skins in said step of applying a dye to the skins includes the step of applying an aqua ammonia solution to the skins.

8- The method of claim 7 wherein said penetrator and said dyestuffs are mixed and heated to a temperature of approximately 200° F. and then cooled to a temperature of approximately 100° F. before introduction to the skins.

9- The method of claim 8 wherein said step of neutralizing the skins is performed in a float of water at approximately 100° F.

10- The method of claim 9 wherein at least portions of said degreasing step and at least portions of said neutralizing step occur simultaneously.

11- The method of claim 10 wherein said degreasing step and said neutralizing step are performed in a float of water at approximately 100° F.

12- The method of claim 11 wherein said first fixing step is further defined as introducing formic acid to the skins.

13- The method of claim 12 wherein said second fixing step is further defined as introducing formic acid to the skins.

14- A method for producing leather from skins, comprising the steps of:
introducing the skins into a mill;
introducing a degreasing agent into the mill;
neutralizing the skins by introducing a base into the mill to raise the pH level of the skins to a range between approximately 5.7 and 6.2;
applying a waterproofing agent to the skins by introducing the waterproofing agent into the mill after said neutralizing step;
coloring the skins by introducing a dyestuff into the mill;
fixing the waterproofing agent and dyestuff within the skins by introducing an acid without metal salt into the mill to lower the pH level of the skins to below approximately 3.5;
applying a water repellant and oil repellant agent to the skins in a fluorchemical process;
fixing the water repellant and oil repellant agent within the skins by introducing as acid without metal salt into the mill to provide the skins with a pH level within a range of approximately 3.0 to 3.5;
introducing an antimicrobial treatment into the mill; and
introducing an antistatic treatment into the mill.

15- The method of claim 14 wherein said coloring step includes the steps of:
raising the pH level of the skins to approximately 7.0 by introducing a base into the mill;
adding a penetrator to the mill; and
adding a desired dyestuff to the mill.

16- The method of claim 15 wherein said coloring step further includes the steps of mixing the penetrator and the dyestuff together before adding the penetrator and the dyestuff to the mill.

17- The method of claim 16 wherein the penetrator and the dyestuff are heated to a temperature of approximately 200° F. and then cooled to a temperature of approximately 100° F.

18- The method of claim 17 wherein the penetrator and the dyestuff are mixed together with water prior to introduction into the mill.

19- The method of claim 14 wherein the waterproofing agent includes Xeroderm P-AF.

20- A method for producing leather from pig skins, comprising the steps of:
introducing wet blue pig skins into a mill containing a float of water, the skins having a weight;
applying a degreasing agent to the skins by introducing the degreasing agent into the water and running the mill for at least approximately thirty minutes, the degreasing agent having a weight of approximately 0.3% percent of the weight of the skins;
neutralizing the skins by introducing a base into the water and running the mill to bring the pH level of the skins to approximately 5.7 or above;
waterproofing the skins by introducing a waterproofing agent into the water and running the mill for at least approximately 60 minutes, the waterproofing agent having a weight of approximately 14 percent of the weight of the skins;
introducing a base into the water to bring the pH level of the skins to approximately 7.0;
coloring the skins by introducing a penetrator and a dyestuff into the water; the penetrator having a weight of at least approximately 1% of the weight of the skins;
fixing the waterproofing agent and the dyestuff in the skins by introducing an acid into the water and lowering the pH level to 3.5 or below;
applying a water repellant and oil repellant agent to the skins by introducing the water repellant and oil repellant agent into the water, the water repellant and oil repellant agent having a weight of at least approximately 3% of the weight of the skins; and
fixing the water repellant and oil repellant agent within the skins by introducing an acid into the water and bringing the pH level of the skins to a range between approximately 3.0 and 3.5.

21- The method of claim 20 further comprising the steps of:
applying an antimicrobial treatment to the skins by introducing an antimicrobial agent to the water, the antimicrobial agent having a weight of approximately 0.32% of the weight of the skins; and
applying an antistatic treatment to the skins by introducing an antistatic agent to the water, the antistatic agent having a weight of approximately 1% of the weight of the skins.

22- The method of claim 21 wherein the waterproofing agent includes Xeroderm P-AF.
